(19) United States
(12) Patent Application Publication
(10) Pub. No.: US 2025/0227490 A1
(43) Pub. Date: Jul. 10, 2025

(54) REFERENCE SIGNAL ASSOCIATIONS FOR PREDICTIVE BEAM MANAGEMENT

(71) Applicant: QUALCOMM Incorporated, San Diego, CA (US)

(72) Inventors: Qiaoyu LI, Beijing (CN); Tao LUO, San Diego, CA (US); Wooseok NAM, San Diego, CA (US); Mahmoud TAHERZADEH BOROUJENI, San Diego, CA (US)

(21) Appl. No.: 18/852,596

(22) PCT Filed: Jun. 8, 2022
(86) PCT No.: PCT/CN2022/097545

§ 371 Date: Sep. 30, 2024

(51) Int. Cl. H04W 16/28; H04B 7/06; H04L 5/00; H04W 72/21; H04W 72/566

(52) U.S. Cl. CPC H04W 16/28; H04B 7/0626; H04L 5/0051; H04W 72/21; H04W 72/566

(57) ABSTRACT

Wireless communications systems, apparatuses, and methods are provided. A method of wireless communication may include transmitting, by a first wireless communication device to a second wireless communication device, a first reference signal having a first beam direction, receiving, by the first wireless communication device from the second wireless communication device, a second reference signal having a second beam direction, and transmitting, by the first wireless communication device to the second wireless communication device, an indicator indicating a difference between a first angle associated with the first beam direction and a second angle associated with the second beam direction

### TECHNICAL FIELD

This application relates to wireless communication systems, and more particularly, to reference signal associations for predictive beam management.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, method of wireless communication may include transmitting, by a first wireless communication device to a second wireless communication device, a first reference signal having a first beam direction; receiving, by the first wireless communication device from the second wireless communication device, a second reference signal having a second beam direction; and transmitting, by the first wireless communication device to the second wireless communication device, an indicator indicating a difference between a first angle associated with the first beam direction and a second angle associated with the second beam direction.

In an additional aspect of the disclosure, a method of wireless communication performed by a user equipment (UE) may include transmitting, to a network unit, a request in a first serving cell for a reference signal associated with a second serving cell, wherein the second serving cell is different from the first serving cell; receiving, from the network unit based on the request, an indicator indicating resources for the reference signal associated with the second serving cell; receiving, from the network unit, the reference signal associated with the second serving cell; and transmitting, to the network unit based on the reference signal associated with the second serving cell, a physical uplink shared channel (PUSCH) scheduled in the second serving cell.

In an additional aspect of the disclosure, first wireless communication device may include a memory; a transceiver; and at least one processor coupled to the memory and the transceiver, wherein the first wireless communication device is configured to transmit, to a second wireless communication device, a first reference signal having a first beam direction; receive, from the second wireless communication device, a second reference signal having a second beam direction; and transmit, to the second wireless communication device, an indicator indicating a difference between a first angle associated with the first beam direction and a second angle associated with the second beam direction.

In an additional aspect of the disclosure, a user equipment (UE) may include a memory; a transceiver; and at least one processor coupled to the memory and the transceiver, wherein the UE is configured to transmit, to a network unit, a request in a first serving cell for a reference signal associated with a second serving cell, wherein the second serving cell is different from the first serving cell; receive, from the network unit based on the request, an indicator indicating resources for the reference signal associated with the second serving cell; receive, from the network unit, the reference signal associated with the second serving cell; and transmit, to the network unit based on the reference signal associated with the second serving cell, a physical uplink shared channel (PUSCH) scheduled in the second serving cell.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure.

FIG. 3 illustrates an example of wireless communication network according to some aspects of the present disclosure.

FIG. 4 illustrates an example of wireless communication network according to some aspects of the present disclosure.

FIG. 5 is a signaling diagram of a wireless communication method according to some aspects of the present disclosure.

FIG. 6 is a signaling diagram of a wireless communication method according to some aspects of the present disclosure.

FIG. 7 is a signaling diagram of a wireless communication method according to some aspects of the present disclosure.

FIG. 8 is a block diagram of an exemplary user equipment (UE) according to some aspects of the present disclosure.

FIG. 9 is a block diagram of an exemplary network unit according to some aspects of the present disclosure.

FIG. 10 is a flow diagram of a communication method according to some aspects of the present disclosure.

FIG. 11 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about at least 70 percent (%).

Some sidelink systems may operate over a 20 MHz bandwidth, e.g., for listen before talk (LBT) based channel accessing, in an unlicensed band. A BS may configure a sidelink resource pool over one or multiple 20 MHz LBT sub-bands for sidelink communications. A sidelink resource pool is typically allocated with multiple frequency subchannels within a sidelink band width part (SL-BWP) and a sidelink UE may select a sidelink resource (e.g., one or multiple subchannels in frequency and one or multiple slots in time) from the sidelink resource pool for sidelink communication.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

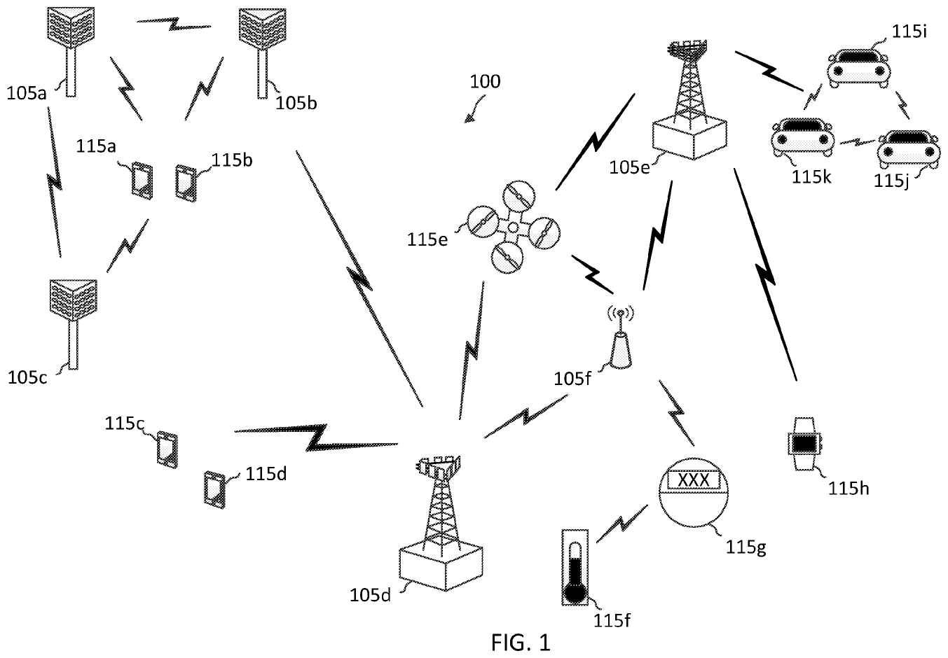

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

In some aspects, the UE 115 may transmit, to the BS 105 a first reference signal having a first beam direction. The UE 115 may receive, from the BS 105, a second reference signal having a second beam direction. The UE 115 may transmit, to the BS 105, an indicator indicating a difference between a first angle associated with the first beam direction and a second angle associated with the second beam direction.

In some aspects, the BS 105 may transmit, to the UE 115 a first reference signal having a first beam direction. The BS 105 may receive, from the UE 115, a second reference signal having a second beam direction. The BS 105 may transmit, to the UE 115, an indicator indicating a difference between a first angle associated with the first beam direction and a second angle associated with the second beam direction.

In some aspects, the UE 115 may transmit, to the BS 105, a request in a first serving cell for a reference signal associated with a second serving cell. The second serving cell may be different from the first serving cell. The UE 115 may receive, from the BS 105 based on the request, an indicator indicating resources for the reference signal associated with the second serving cell. The UE 115 may receive, from the BS 105, the reference signal associated with the second serving cell. The UE 115 may transmit, to the BS 105 based on the reference signal associated with the second serving cell, a physical uplink shared channel (PUSCH) scheduled in the second serving cell.

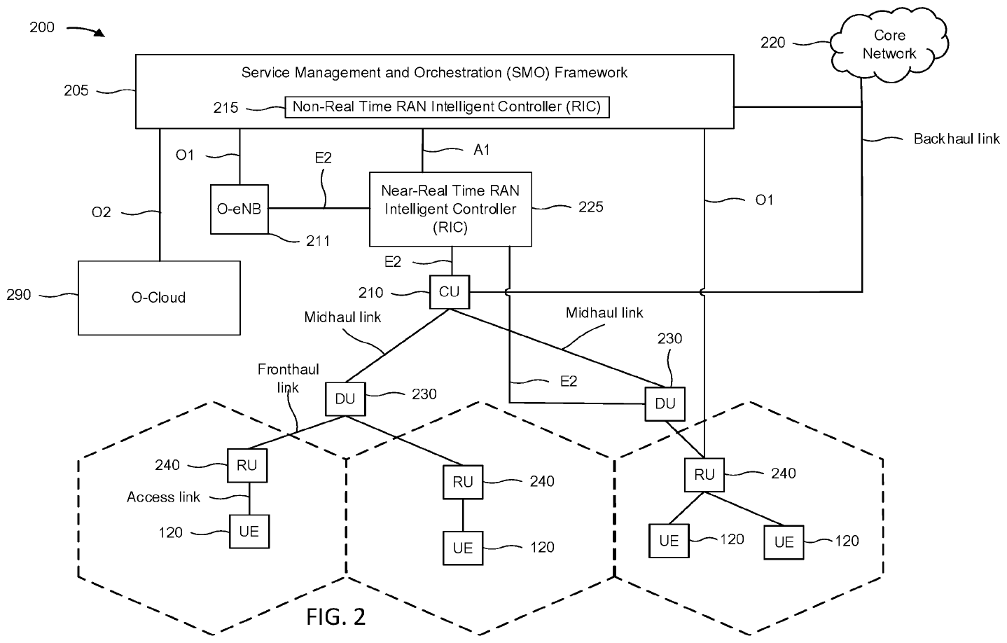

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 120 via one or more radio frequency (RF) access links. In some implementations, the UE 120 may be simultaneously served by multiple RUs 240.

Each of the units, i.e., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 120. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

In some aspects, a method of wireless communication may be performed by the UE 120. The method may include monitoring a first set of physical downlink control channel (PDCCH) candidate resources for a PDCCH communication from the RU 240, receiving, from the RU 240, a plurality of demodulation reference signals (DMRSs) and decoding, based on a metric associated with the plurality of demodulation reference signals (DMRSs) satisfying a threshold, the PDCCH communication.

In some aspects, a first UE 120 may transmit a configuration to a second UE 120 indicating at least one of a length associated with a sidelink synchronization signal block (S-SSB) burst, a quasi-colocation (QCL) index associated with the S-SSB burst, or a first QCL order associated with the S-SSB burst. In some aspects, the first UE 120 may transmit the S-SSB burst to the second UE 120 based on the at least one of the length associated with the S-SSB burst, the QCL index associated with the S-SSB burst, or the first QCL order associated with the S-SSB burst.

In some aspects, a first UE 120 may transmit to the RU 240, an indication associated with channel occupancy time (COT) sharing on sidelink communication. The first UE 120 may receive, from the RU 240, a COT indicator, wherein the COT indicator indicates to the first UE 120 to initiate a COT on sidelink communication based on the indication associated with the COT sharing or the COT indicator indicates to the first UE 120 to share the COT on sidelink communication based on the indication associated with the COT sharing on sidelink communication. The first UE 120 may transmit, to a second UE 120, a communication during the COT on sidelink communication.

In some aspects, the UE 120 may transmit, to the RU 240 a first reference signal having a first beam direction. The UE 120 may receive, from the RU 240, a second reference signal having a second beam direction. The UE 120 may transmit, to the RU 240, an indicator indicating a difference between a first angle associated with the first beam direction and a second angle associated with the second beam direction.

In some aspects, the RU 240 may transmit, to the UE 120 a first reference signal having a first beam direction. The RU 240 may receive, from the UE 120, a second reference signal having a second beam direction. The RU 240 may transmit, to the UE 120, an indicator indicating a difference between a first angle associated with the first beam direction and a second angle associated with the second beam direction.

In some aspects, the UE 120 may transmit, to the RU 240, a request in a first serving cell for a reference signal associated with a second serving cell, wherein the second serving cell is different from the first serving cell. The UE 120 may receive, from the RU 240 based on the request, an indicator indicating resources for the reference signal associated with the second serving cell. The UE 120 may receive, from the RU 240, the reference signal associated with the second serving cell. The UE 120 may transmit, to the RU 240 based on the reference signal associated with the second serving cell, a physical uplink shared channel (PUSCH) scheduled in the second serving cell.

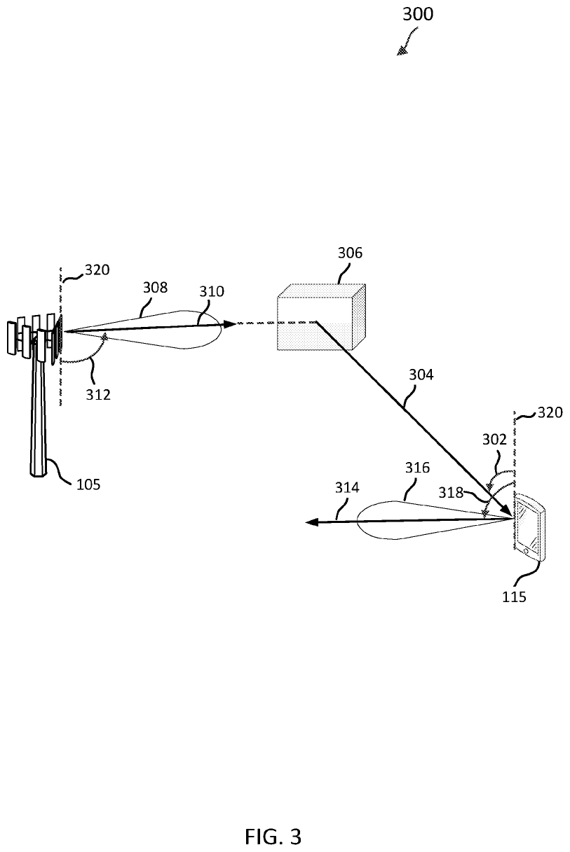

FIG. 3 illustrates an example of wireless communication network 300 according to some aspects of the present disclosure. Wireless communication network 300 may include network unit 105 and UE 115. In some aspects, a first wireless communication device may transmit a first reference signal having a first beam direction to a second wireless communication device. In FIG. 3, the UE 115 may transmit a first reference signal having a first beam direction to the network unit 105.

In some aspects, the UE 115 transmitting the first reference signal may include the UE 115 transmitting a plurality of first reference signals. The first reference signal(s) may be transmitted in at least frequency range 1 (FR1). In some instances, the FR1 may include frequencies in the range of about 4.1 GHz to about 7.125 GHz. In addition to or in lieu of FR1, the first reference signal(s) may be transmitted in one or more other frequency ranges.

In some aspects, the first reference signal(s) may be transmitted in a first beam direction (e.g., a beam pointing direction). The UE 115 may support directional beamforming (e.g., spatial filtering, directional transmission, and/or directional reception) that may enable the UE 115 to transmit the first reference signal(s) in one or more particular directions. Directional beamforming may enable the UE 115 to shape and/or steer the transmission of the first reference signal(s) in a first beam direction along a spatial path between the UE 115 and the network unit 105. Beamforming may be achieved by combining signals communicated via antenna elements of the UE 115 such that some signals propagating at particular orientations with respect to the antenna array experience constructive interference while others experience destructive interference. The adjustment of signals communicated via the antenna elements may include applying amplitude offsets, and/or phase offsets to the first reference signal carried via the antenna elements associated with the UE 115.

In the example of FIG. 3, the first reference signal may be a sounding reference signal (SRS). The SRS may be a known sequence (e.g., a Zadoff-Chu sequence or other sequence) transmitted by the UE 115 to the network unit 105 to enable the network unit 105 to estimate an uplink channel. The SRS may provide the network unit information about the effects of multipath fading, scattering, Doppler, and/or power loss of the transmitted SRS.

In some aspects, the UE 115 may receive a second reference signal having a second beam direction from the network unit 105. In some aspects, the UE 115 receiving the second reference signal may include the UE 115 receiving a plurality of second reference signals. The second reference signal(s) may be received in at least frequency range 1 (FR1). In some instances, the FR1 may include frequencies in the range of about 4.1 GHz to about 7.125 GHz. In addition to or in lieu of FR1, the second reference signal(s) may be received in one or more other frequency ranges.

In some aspects, the second reference signal may be received via reflected beam 304 (e.g., a beam arrival direction). The reflected beam 304 may have a beam angle of arrival (AOA) 302 at the UE 115. The beam AOA 302 at the UE 115 may be different from the direction that the second reference signal was transmitted by the network unit 105 (e.g., the beam pointing direction 310 of the transmitted second reference signal). The beam AOA 302 may be different from the beam pointing direction 310 of the second reference signal due to multipath reflections in the communications channel. In some aspects, the second reference signal may be a CSI-RS, an SSB, and/or other signal.

In some aspects, the UE 115 may transmit an indicator to the network unit 105 indicating a difference between a first angle (e.g., angle 318) associated with the first beam direction and a second angle (e.g., beam AOA 302) associated with the second beam direction. In this regard, the UE 115 may transmit the indicator via at least one of a channel state information (CSI) report, a medium access control control element (MAC-CE), and/or uplink control information (UCI).

The UE 115 may transmit the indicator multiplexed with other indicators and/or data (e.g., multiplexed with hybrid automatic repeat request (HARQ) feedback, channel state information (CSI), a scheduling request (SR), and/or other indicators/data). In this regard, the UE 115 may transmit the indicator frequency multiplexed with other indicators and/or data. Additionally or alternatively, the UE 115 may transmit the indicator time multiplexed with other information and/or data. In some aspects, the UE 115 may transmit the indicator multiplexed with other information and/or data based on a priority level associated with the indicator. In some aspects, the UCI may have a limited payload size and certain information (e.g., indicators, control data, HARQ feedback) may be included or omitted from the UCI payload based on priority levels associated with the information (e.g., priority levels of the indicators, control data, feedback) carried by the UCI. In some instances, the UE 115 may receive the priority level(s) associated with the information to be carried by the UCI from the network unit. In some aspects, the priority level associated with the beam angle indicator may be based on the difference between the first angle (e.g., angle 318) associated with the first beam direction and the second angle (e.g., beam AOA 302) associated with the second beam direction. For example, a smaller difference between the first and second angle may decrease the indicator priority level, whereas a larger difference between the first and second angle may increase the indicator priority level.

In some aspects, the first reference signal and the second reference signal may be associated with a first serving cell. The first serving cell may operate in an FR1 frequency band. The network unit 105 may transmit the indicator to the UE 115 via DCI that schedules a physical uplink shared channel (PUSCH) associated with a second serving cell. The second serving cell may be different from the first serving cell. The second serving cell may operate in an FR2 frequency range. In some instances, the FR2 frequency range may include frequencies in the range of about 24.25 GHz to about 52.6 GHz. In addition to or in lieu of FR2, the second serving cell may operate in one or more other frequency ranges. For example, the second serving cell may operate in frequency ranges above 52.6 GHz. In some aspects, the UE 115 may use the received indicator to determine uplink precoding parameters for the PUSCH scheduled for transmission by the UE 115 in the second serving cell. The UE 115 may transmit the scheduled PUSCH to the network unit using the determined precoding parameters.

In some aspects, the network unit 105 may transmit DCI to the UE 115 that includes a sounding reference signal resource indicator (SRI) and/or a transmit precoding matrix index (TPMI) associated with the first serving cell. The SRI may indicate to the UE 115 one or more SRS resources from an SRS resource set that are associated with SRS reference signals associated with the first cell (e.g., in FR1). The TPMI may indicate to the UE 115 one or more precoding parameters associated with the scheduled PUSCH message.

In some aspects, the first angle 318 associated with the first beam direction may be based on a beam pointing direction 314 (e.g., beam transmission direction from the UE 115). The beam pointing direction 314 may be a center line of a transmission beam lobe 316. For example, the UE 115 may have a beam pointing direction 314 of transmission beam lobe 316. Network unit 105 may have a beam pointing direction 310 of transmission beam lobe 308. The first angle may be an angle 318 between the beam pointing direction 314 and a reference line 320 (e.g., a vertical reference line). The UE 115 may transmit the first reference signal (e.g., an SRS) intended for the network unit 105 along beam pointing direction 314. The second angle associated with the second beam direction may be a beam angle of arrival (AOA) 302. Beam AOA 302 may be an angle between the second reference signal (e.g., CSI-RS, SSB) received on reflected beam 304 and reference line 320. Network unit 105 may transmit the second reference signal along pointing direction 310. The second reference signal may be reflected off the object 306 and/or other objects. The reflected second reference signal may propagate on as reflected beam 304 to the UE 115. The UE 115 may measure the beam AOA 302 associated with the second reference signal using any suitable method. For example, the UE 115 may measure the beam AOA 302 associated with a plurality of delay paths based on a time difference of arrival and/or a received phase associated with the second reference signal. The beam AOA 302 may be represented as an azimuth angle and/or an elevation angle relative to the reference line 320 and/or other suitable reference line(s). The UE 115 may determine a difference between the angle 318 associated with the beam pointing direction 314 and the AOA 302 associated with the reflected beam 304 (e.g., the second beam direction). The UE 115 may transmit the indicator indicating the difference between the angles of the transmitted first reference signal and the received second reference signal to the network unit 105.

In some aspects, a smaller difference between the angles may indicate a better alignment and/or a better channel between the UE 115 and network unit 105 as compared to a larger difference between the first and second angles. A better channel between the UE 115 and network unit 105s may increase the performance and/or efficiency of the communication between the network unit 105 and the UE 115. In some aspects, the difference between the first angle associated with the first beam direction in FR1 and the second angle associated with the second beam direction in FR1 may be used as a proxy for estimating channel conditions and/or beam failures between the network unit 105 and the UE 115 when operating in FR2 (e.g., when the UE 115 transmits a PUSCH in a second serving cell operating in FR2). For example, a UE 115 may determine a beam failure associated with the second serving cell operating in FR2 based on reference signals in the first serving cell operating in FR1. In some instances, the UE 115 may determine the beam failure associated with the second serving cell based on a power delay profile (PDP) and/or an AOA of the reference signals in the first serving cell. In some instances, the UE 115 may determine the beam failure associated with the second serving cell based on the PDP using one or more of a received signal strength indicator (RSSI) associated with the reference signals in the first serving cell, a reference signal received power (RSRP) associated with the reference signals in the first serving cell, a number of delay paths associated with the reference signals in the first serving cell, a reference signal received quality (RSRQ) associated with the reference signals in the first serving cell, and/or a signal-to-noise and interference ratio (SINR) associated with the reference signals in the first serving cell. In some instances, the UE 115 may determine the beam failure associated with the second serving cell based on the beam AOA 302 using one or more of a time difference of arrival and/or a received phase associated with the reference signals in the first serving cell.

Additionally or alternatively, the UE may report the indicator as a difference between the beam pointing direction 314 of the reference signal transmitted by the UE 115 and the beam pointing direction 310 of the reference signal transmitted by the network unit 105. In this regard, the network unit 105 may transmit a message to the UE 115 indicating the angle 312 of beam pointing direction 310. The UE may determine the difference between angle 318 of the beam pointing direction 314 and the angle 312 of the beam pointing direction 310. The UE 115 may transmit the indicator indicating the difference in angles to the network unit 105.

In some aspects, the indicator indicating the difference between the first and second angles may indicate the difference in a number of degrees. The indicator may indicate the difference as a whole and/or fractional number of degrees. In some aspects, the indicator may indicate the difference as being within a range of degrees (e.g., between 0 and 5 degrees, between 5 and 10 degrees, or any suitable range(s) of degrees), with each range of degrees having an associated value or identifier.

In some aspects, the indicator may be a binary indicator (e.g., “0” or “1”) indicating whether the difference between the first angle and the second angle satisfies a threshold. For example, the binary indicator may indicate whether the difference is greater than (and/or equal to) a threshold or less than (and/or equal to) a threshold. In some aspects, the binary indicator may indicate whether the difference is within a range of degrees or out of a range of degrees.

In some aspects, the indicator indicating the difference between the first and second angles may indicate the difference relative to a previous indicator. For example, a first indicator may indicate the difference in a number of degrees. Subsequent indicators may indicate the difference in degrees or other values (e.g., based on one or more ranges) as a delta to the previously indicated number of degrees or other value.

In some aspects, the UE 115 may transmit the indicator to the network unit 105 on a periodic, a semi-persistent, and/or an aperiodic basis. For example, the UE 115 may receive a request for the indicator from the network unit 105. The UE 115 may transmit the indicator in response to receiving the request. In this regard, the UE 115 may receive the request via at least one of a radio resource control (RRC) message, a semi-persistent activation state configuration via a medium access control control element (MAC-CE), an aperiodic triggering state configuration downlink control information (DCI), a channel state information (CSI) report setting, a MAC-CE, and/or downlink control information (DCI).

In some aspects, the UE 115 may transmit the indicator to the network unit based on a change (e.g., a rate of change and/or absolute change) in the difference between the first angle and the second angle. For example, the UE 115 may detect a rate of change in the angle difference over a time period. A change in orientation (e.g., vertical orientation and/or horizontal orientation) of the UE (e.g., when a user rotates the UE 115) may cause a change in the angle difference. The UE 115 may transmit the indicator to the network unit 105 based on a rate of change in the angle difference satisfying a threshold (e.g., exceeding and/or equaling the threshold).

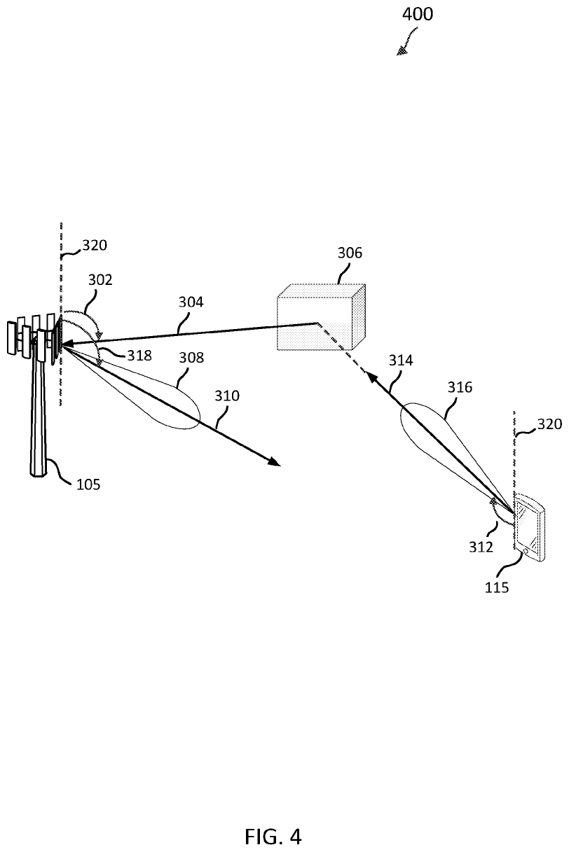

FIG. 4 illustrates an example of wireless communication network 400 according to some aspects of the present disclosure. Wireless communication network 400 may include network unit 105 and UE 115. The example of FIG. 4 is similar to the example of FIG. 3 with the reversal of the directions associated with first reference signal and the second reference signal. In some aspects, a first wireless communication device may transmit a first reference signal having a first beam direction to a second wireless communication device. In the example of FIG. 4, the network unit 105 may transmit a first reference signal having a first beam direction to the UE 115.

In some aspects, the network unit 105 transmitting the first reference signal may include the network unit 105 transmitting a plurality of first reference signals. The first reference signal(s) may be transmitted in at least frequency range 1 (FR1). In some instances, the FR1 may include frequencies in the range of about 4.1 GHz to about 7.125 GHz. In addition to or in lieu of FR1, the first reference signal(s) may be transmitted in one or more other frequency ranges.

In some aspects, the first reference signal may be transmitted in a first beam direction (e.g., a beam pointing direction). The network unit 105 may support directional beamforming (e.g., spatial filtering, directional transmission, and/or directional reception) that may enable the network unit 105 to transmit the first reference signal(s) in one or more particular directions. Directional beamforming may enable the network unit 105 to shape and/or steer the transmission of the first reference signal(s) in a first beam direction along a spatial path between the network unit 105 and the UE 115. Beamforming may be achieved by combining signals communicated via antenna elements of the network unit 105 such that some signals propagating at particular orientations with respect to the antenna array experience constructive interference while others experience destructive interference. The adjustment of signals communicated via the antenna elements may include applying amplitude offsets, and/or phase offsets to the first reference signal carried via the antenna elements associated with the network unit 105.

In the example of FIG. 4, the first reference signal may be a channel state information-reference signal (CSI-RS). The CSI-RS may be a reference signal used in the downlink direction for the purpose of channel sounding and may be used by the UE 115 to measure one or more characteristics of the radio channel. The CSI-RSs may include zero power channel state information reference signals (ZP-CSI-RSs) and/or non-zero power channel state information reference signals (NZP-CSI-RSs). Additionally or alternatively, the first reference signal may be a synchronization signal block (SSB). The SSB may include a primary synchronization signal (PSS) and/or a secondary synchronization signal (SSS). The SSB may be transmitted by the network unit over a physical broadcast channel (PBCH). The PSS may enable timing synchronization (e.g., of a period and/or periodicity) and/or may indicate a physical layer identity value. The network unit may then transmit an SSS. The SSS may be associated with the PSS. The SSS may enable radio frame synchronization and/or may provide a cell identity value. In some instances, the cell identify value of the SSS may be combined with the physical layer identity value of the PSS to identify the cell.

The second reference signal may be a sounding reference signal (SRS). The SRS may be a known sequence (e.g., a Zadoff-Chu sequence or other sequence) transmitted by the UE 115 to the network unit 105 to enable the network unit 105 to estimate an uplink channel. The SRS may provide the network unit information about the effects of multipath fading, scattering, Doppler, and/or power loss of the transmitted SRS.

In some aspects, the network unit 105 may receive a second reference signal having a second beam direction from the UE 115. In some aspects, the network unit 105 receiving the second reference signal may include the network unit 105 receiving a plurality of second reference signals. The second reference signal(s) may be received in at least frequency range 1 (FR1). In some instances, the FR1 may include frequencies in the range of about 4.1 GHz to about 7.125 GHz. In addition to or in lieu of FR1, the second reference signal(s) may be received in one or more other frequency ranges.

In some aspects, the second reference signal may be received by the network unit 105 in a reflected beam 304 (e.g., a beam arrival direction). The reflected beam 304 may have a beam angle of arrival (AOA) 302 at the network unit 105. The beam AOA 302 at the network unit 105 may be different from the direction that the second reference signal was transmitted by the UE 115 (e.g., the beam pointing direction 314 of the transmitted second reference signal). The beam AOA 302 may be different from the beam pointing direction 314 of the second reference signal due to multipath reflections in the communications channel. In some aspects, the second reference signal may be a SRS and/or other signal.

In some aspects, the network unit 105 may transmit an indicator to the UE 115 indicating a difference between a first angle (e.g., angle 318) associated with the beam pointing direction 310 and a second angle (e.g., AOA 302) associated with the second beam direction. In this regard, the network unit 105 may transmit the indicator to the UE 115 via at least one of a RRC message, a medium access control control element (MAC-CE), and/or downlink control information (DCI).

In some aspects, the first reference signal and the second reference signal may be associated with a first serving cell. The first serving cell may operate in an FR1 frequency band. The network unit 105 may transmit the indicator to the UE 115 via DCI that schedules a physical uplink shared channel (PUSCH) associated with a second serving cell. The second serving cell may be different from the first serving cell. The second serving cell may operate in an FR2 frequency range. In some instances, the FR2 frequency range may include frequencies in the range of about 24.25 GHz to about 52.6 GHz. In addition to or in lieu of FR2, the second serving cell may operate in one or more other frequency ranges. For example, the second serving cell may operate in frequency ranges above 52.6 GHz. In some aspects, the UE 115 may use the received indicator to determine uplink precoding parameters for the PUSCH scheduled for transmission by the UE 115 in the second serving cell. The UE 115 may transmit the scheduled PUSCH to the network unit using the determined precoding parameters.

In some aspects, the network unit 105 may transmit DCI to the UE 115 that includes a sounding reference signal resource indicator (SRI) and/or a transmit precoding matrix index (TPMI) associated with the first serving cell. The SRI may indicate to the UE 115 one or more SRS resources from an SRS resource set that are associated with SRS reference signals associated with the first cell (e.g., in FR1). The TPMI may indicate to the UE 115 one or more precoding parameters associated with the scheduled PUSCH message.

In some aspects, the first angle 318 associated with the first beam direction may be based on a beam pointing direction 310 (e.g., beam transmission direction from the network unit 105). The beam pointing direction 310 may be a center line of a transmission beam lobe 308. For example, the network unit 105 may have a beam pointing direction 310 of transmission beam lobe 308. The first angle may be an angle 318 between the beam pointing direction 310 and a reference line 320 (e.g., a vertical reference line). The network unit 105 may transmit the first reference signal (e.g., a CSI-RS or SSB) intended for the UE 115 along beam pointing direction 310. The second angle associated with the second beam direction may be AOA 302 at the network unit 105. Beam AOA 302 may be an angle between the second reference signal (e.g., SRS from the UE 115) received on reflected beam 304 and reference line 320. The UE 115 may transmit the second reference signal along beam pointing direction 314. The second reference signal may be reflected off the object 306 and/or other objects. The reflected second reference signal may propagate on as reflected beam 304 to the network unit 105. The network unit 105 may measure the beam AOA 302 associated with the second reference signal using any suitable method. For example, the network unit 105 may measure the beam AOA 302 associated with a plurality of delay paths based on a time difference of arrival and/or a received phase associated with the second reference signal. The beam AOA 302 may be represented as an azimuth angle and/or an elevation angle relative to the reference line 320 and/or other suitable reference line(s). The network unit 105 may determine a difference between the angle 318 associated with the beam pointing direction 310 and the beam AOA 302 associated with the reflected beam 304 (e.g., the second beam direction). The network unit 105 may transmit the indicator indicating the difference between the angles of the transmitted first reference signal and the received second reference signal to the UE 115. In some aspects, the network unit 105 may transmit the indicator to the UE 115 on a periodic, a semi-persistent, and/or an aperiodic basis.

In some aspects, the network unit 105 may transmit the indicator to the UE 115 based on a change (e.g., a rate of change and/or absolute change) in the difference between the first angle and the second angle. For example, the network unit 105 may detect a rate of change in the angle difference over a time period. The network unit 105 may transmit the indicator to the UE 115 based on a rate of change in the angle difference satisfying a threshold (e.g., exceeding and/or equaling the threshold).

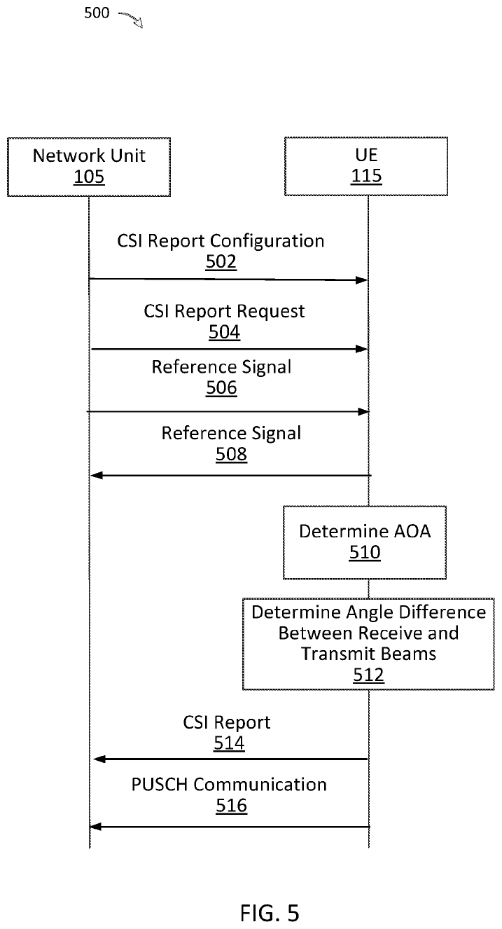

FIG. 5 is a signaling diagram of a wireless communication method 500 according to some aspects of the present disclosure. Actions of the communication method 500 can be executed by a computing device (e.g., a processor, processing circuit, and/or other suitable component) of a communication device or other suitable means for performing the actions. For example, a wireless communication device, such as the UE 115, UE 120, or UE 800, may utilize one or more components, such as the processor 802, the memory 804, the beam angle module 808, the transceiver 810, the modem 812, and the one or more antennas 816, to execute aspects of method 500. A wireless communication device, such as the BS 105, the CU 1210, the DU 1230, the RU 1240, and/or the network unit 900 may utilize one or more components, such as the processor 902, the memory 904, the beam angle module 908, the transceiver 910, the modem 912, and the one or more antennas 916, to execute aspects of method 500.

At action 502, the method 500 may include the network unit 105 transmitting a CSI report setting to the UE 115. In this regard, the network unit 105 may transmit the CSI report configuration to the UE 115 via an aperiodic triggering state configuration downlink control information (DCI), DCI, a radio resource control (RRC) message, a semi-persistent activation state configuration via a medium access control control element (MAC-CE), a MAC-CE, a PDCCH message, a PDSCH message, or other suitable communication.

In some aspects, the CSI report configuration may indicate one or more threshold values. For example, the CSI report configuration may indicate a first threshold, a second threshold, a third threshold, etc. associated with the difference in angles associated with the reference signal(s) (e.g., as described with reference to FIGS. 3 and 4 above). In some aspects, the CSI report configuration may indicate the number of CSI reports the UE 115 should transmit to the network unit 105 for each CSI reporting instance. The CSI report configuration may indicate one or more periodicities at which the network unit 105 may receive the CSI report(s) from the UE 115. The CSI report configuration may indicate a reference signal configuration.

At action 504, the method 500 may include the network unit 105 transmitting a CSI report request to the UE 115. In this regard, the network unit 105 may transmit the CSI report request to the UE 115 via an aperiodic triggering state configuration downlink control information (DCI), DCI, a radio resource control (RRC) message, a semi-persistent activation state configuration via a medium access control control element (MAC-CE), a MAC-CE, a PDCCH message, a PDSCH message, or other suitable communication.

At action 506, the method 500 may include the network unit 105 transmitting one or more reference signals to the UE 115. The one or more reference signals may include a CSI-RS(s) and/or SSB(s) and/or other suitable reference signal(s).

At action 508, the method 500 may include the UE 115 transmitting one or more reference signals to the network unit 105. The one or more reference signals may include a SRS and/or other suitable reference signal(s).

At action 510, the method 500 may include the UE 115 determining an AOA of the one or more reference signals (e.g., reflected reference signals) received at action 506. In this regard, the UE 115 may measure the beam AOA associated with the reference signal(s) using any suitable method. For example, the UE 115 may measure the beam AOA associated with a plurality of delay paths of the received reference signal(s) based on a time difference of arrival and/or a received phase associated with the reference signal(s). The beam AOA may be represented as an azimuth angle and/or an elevation angle relative to a suitable reference line(s). The UE 115 may determine a difference between the angle associated with the reference signa(s) transmitted at action 508 and the beam AOA associated with reference signal(s) received at action 506.

At action 512, the method 500 may include the UE 115 determining a difference between the AOA associated with the reference signal(s) received at action 506 and the angle of the pointing direction of the reference signals transmitted at action 508. Additionally or alternatively, the UE may report the angle indicator as a difference between the beam pointing direction of the reference signal(s) transmitted by the UE 115 and the beam pointing direction of the reference signal(s) transmitted by the network unit 105. In this regard, the network unit 105 may transmit a message to the UE 115 indicating the beam pointing direction of the network unit 105. The UE may determine the angle between the beam pointing direction of the reference signal(s) transmitted by the UE 115 and the beam pointing direction received from the network unit 105.

At action 514, the method 500 may include the UE 115 transmitting a CSI report to the network unit 105. The CSI report may include the indicator indicating the angle difference. In this regard, the UE 115 may transmit the CSI report(s) to the network unit 105 using any suitable communication(s). For example, the UE may transmit the CSI report in a single-part payload and/or a two-part payload via a physical uplink shared channel (PUSCH). In some aspects, the UE may transmit the CSI report via a physical uplink control channel (PUCCH).

At action 516, the method 500 may include the UE 115 transmitting a PUSCH communication to the network unit 105. In some aspects, the UE 115 may use the angle difference indicator to determine uplink precoding parameters for the PUSCH scheduled for transmission by the UE 115. The UE 115 may transmit the scheduled PUSCH to the network unit 105 using the determined precoding parameters. The UE 115 may transmit the PUSCH in a second serving cell using an FR2 frequency.

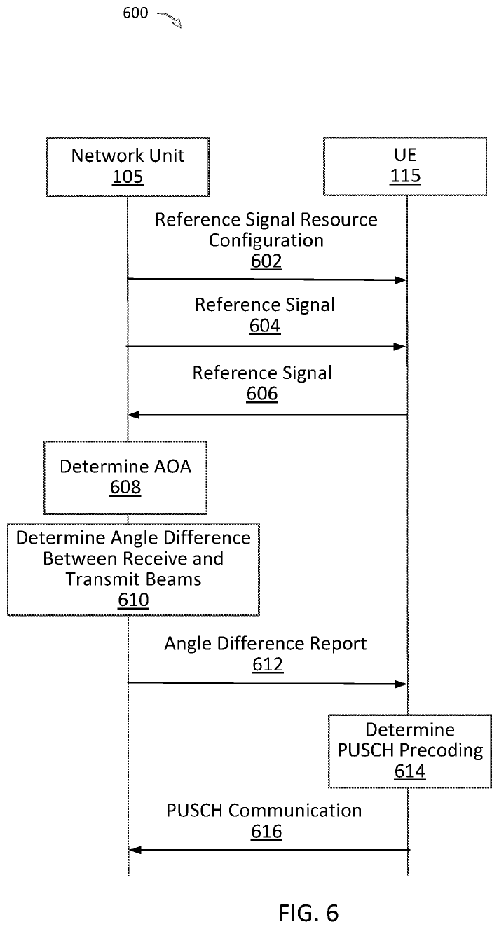

FIG. 6 is a signaling diagram of a wireless communication method 600 according to some aspects of the present disclosure. Actions of the communication method 600 can be executed by a computing device (e.g., a processor, processing circuit, and/or other suitable component) of a communication device or other suitable means for performing the actions. For example, a wireless communication device, such as the UE 115, UE 120, or UE 800, may utilize one or more components, such as the processor 802, the memory 804, the beam angle module 808, the transceiver 810, the modem 812, and the one or more antennas 816, to execute aspects of method 600. A wireless communication device, such as the BS 105, the CU 1210, the DU 1230, the RU 1240, and/or the network unit 900 may utilize one or more components, such as the processor 902, the memory 904, the beam angle module 908, the transceiver 910, the modem 912, and the one or more antennas 916, to execute aspects of method 600.

At action 602, the method 600 may include the network unit 105 transmitting a reference signal resource configuration to the UE 115. In this regard, the network unit 105 may transmit the reference signal resource configuration to the UE 115 via an aperiodic triggering state configuration downlink control information (DCI), DCI, a radio resource control (RRC) message, a semi-persistent activation state configuration via a medium access control control element (MAC-CE), a MAC-CE, a PDCCH message, a PDSCH message, or other suitable communication.

In some aspects, the reference signal resource configuration may indicate parameters associated with time, frequency and/or spatial resources associated with reference signal(s). For example, the reference signal resource configuration may indicate parameters associated with time, frequency and/or spatial resources associated with reference signal(s) transmitted by the network unit 105 to the UE 115. Additionally or alternatively, the reference signal resource configuration may indicate parameters associated with time, frequency and/or spatial resources associated with reference signal(s) transmitted by the UE 115 to the network unit 105.

At action 604, the method 600 may include the network unit 105 transmitting one or more reference signals to the UE 115. The one or more reference signals may include a CSI-RS(s) and/or SSB(s) and/or other suitable reference signal(s).

At action 606, the method 600 may include the UE 115 transmitting one or more reference signals to the network unit 105. The one or more reference signals may include a SRS and/or other suitable reference signal(s).

At action 608, the method 600 may include the network unit 105 determining an AOA of the one or more reference signals (e.g., reflected reference signals) received by the network unit at action 606. In this regard, the network unit 105 may measure the beam AOA associated with the reference signal(s) using any suitable method. For example, the network unit 105 may measure the beam AOA associated with a plurality of delay paths of the received reference signal(s) based on a time difference of arrival and/or a received phase associated with the reference signal(s). The beam AOA may be represented as an azimuth angle and/or an elevation angle relative to a suitable reference line(s). The network unit 105 may determine a difference between the angle associated with the reference signal(s) transmitted at action 604 and the beam AOA associated with reference signal(s) received at action 606.

At action 610, the method 600 may include the network unit 105 determining a difference between the AOA associated with the reference signal(s) received at action 606 and the angle of the pointing direction of the reference signals transmitted at action 604. Additionally or alternatively, the network unit 105 may determine the angle indicator as a difference between the beam pointing direction of the reference signal(s) transmitted by the UE 115 and the beam pointing direction of the reference signal(s) transmitted by the network unit 105. In this regard, the UE 115 may transmit a message to the network unit 105 indicating the beam pointing direction associated with the UE 115. The UE 115 may determine the beam pointing direction based on an orientation of the antenna(s) transmitting the reference signal(s) with respect to the UE 115 and/or an orientation of the UE 115. The UE 115 may determine its orientation based on sensors (e.g., a magnetometer, an inertial measurement unit). The network unit 105 may determine the angle between the beam pointing direction of the reference signal(s) transmitted by the UE 115 and the beam pointing direction received from the network unit 105.

At action 612, the method 600 may include the network unit 105 transmitting an indicator indicating the angle difference to the UE 115. In this regard, the network unit 105 may transmit the indicator to the UE 115 using any suitable communication(s). For example, the network unit 105 may transmit the indicator in an RRC message, a MAC-CE message, and/or DCI.

At action 614, the method 600 may include the UE 115 determining PUSCH precoding parameters. In some aspects, the UE 115 may use the angle difference indicator to determine uplink precoding parameters for the PUSCH scheduled for transmission by the UE 115.

At action 614, the method 600 may include the UE 115 transmitting a PUSCH communication to the network unit 105. The UE 115 may transmit the scheduled PUSCH to the network unit 105 using the precoding parameters determined at action 614. The UE 115 may transmit the PUSCH in a second serving cell using an FR2 frequency.

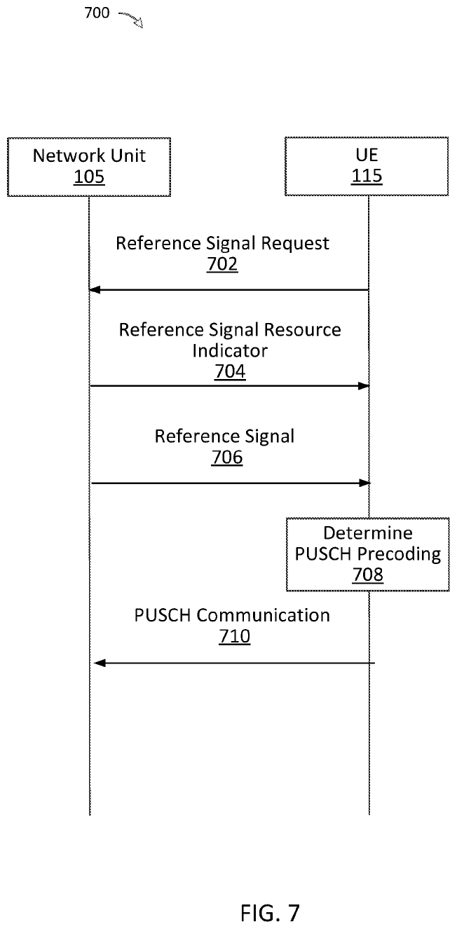

FIG. 7 is a signaling diagram of a wireless communication method 700 according to some aspects of the present disclosure. Actions of the communication method 700 can be executed by a computing device (e.g., a processor, processing circuit, and/or other suitable component) of a communication device or other suitable means for performing the actions. For example, a wireless communication device, such as the UE 115, UE 120, or UE 800, may utilize one or more components, such as the processor 802, the memory 804, the beam angle module 808, the transceiver 810, the modem 812, and the one or more antennas 816, to execute aspects of method 700. A wireless communication device, such as the BS 105, the CU 1210, the DU 1230, the RU 1240, and/or the network unit 900 may utilize one or more components, such as the processor 902, the memory 904, the beam angle module 908, the transceiver 910, the modem 912, and the one or more antennas 916, to execute aspects of method 700.

At action 702, the method 700 may include the UE 115 transmitting a request to network unit 105 in a first serving cell (e.g., an FR1 serving cell) for a reference signal associated with a second serving cell (e.g., an FR2 serving cell). In this regard, the UE 115 may transmit the request to the network unit 105 via UCI, a MAC-CE message, a CSI-RS report, a PUCCH message, and/or a PUSCH message. In some aspects, the reference signal associated with the second serving cell may include at least one of a channel state information reference signal (CSI-RS), a synchronization signal block (SSB), or a demodulation reference signal (DMRS).

In some aspects, the second serving cell may be different from the first serving cell. In this regard, the first serving cell may be a serving cell operating in at least FR1 while the second serving cell may be a serving cell operating in at least FR2. The FR1 may include frequencies in the range of about 4.1 GHz to about 7.125 GHz. In addition to or in lieu of FR1, the first serving cell may operate in one or more other frequency ranges. The FR2 frequency range may include frequencies in the range of about 24.25 GHz to about 52.6 GHz. In addition to or in lieu of FR2, the second serving cell may operate in one or more other frequency ranges. For example, the second serving cell may operate in frequency ranges above 52.6 GHz. In some aspects, the first serving cell may be in a master cell group (MCG) and the second serving cell may be in a secondary cell group (SCG). The wireless network (e.g., wireless network 100, 200, 300, or 400) may operate in a dual connectivity mode in which the UE is connected to the first serving cell in a master cell group (MCG) and the second serving cell in a secondary cell group (SCG). The MCG may be a group of serving cells associated with a master eNB (MeNB) operating at FR1 frequencies and/or one or more other frequency ranges. The SCG may be a group of serving cells associated with a secondary eNB (SeNB) operating at FR2 frequencies and/or one or more other frequency ranges.

In some aspects, the UE 115 may transmit the request for the reference signal associated with the second serving cell based on at least one parameter of a reference signal associated with the first serving cell received from the network unit 105. For example, the at least one parameter of the reference signal associated with the first serving cell may include an RSRP associated with the reference signal satisfying a threshold. In some aspects, the at least one parameter may include a rate of change of the RSRP associated with the reference signal satisfying a threshold. Additionally or alternatively, the UE 115 may transmit the request for the reference signal associated with the second serving cell based on a difference between a scheduled rank associated with a scheduled PUSCH transmission and a determined rank associated with the scheduled PUSCH transmission satisfying a threshold. Additionally or alternatively, the UE 115 may transmit the request for the reference signal associated with the second serving cell based on a difference between a scheduled modulation coding scheme (MCS) associated with the scheduled PUSCH and a determined MCS associated with the scheduled PUSCH satisfying a threshold.

At action 704, the method 700 includes the UE 115 receiving an indicator from the network unit 105 indicating resources for the reference signal associated with the second serving cell. The UE 115 may receive the indicator from the network unit 105 based on the request transmitted at action 702. In this regard, the UE 115 may receive the indicator via downlink control information (DCI) and/or other suitable messaging. The DCI may carry a sounding reference signal resource indicator (SRI) that indicates the spatial resources, time resources, and/or frequency resources for the reference signal associated with the second serving cell. Additionally or alternatively, the DCI may carry a transmit precoding matrix index (TPMI) that indicates the spatial resources, time resources, and/or frequency resources for the reference signal associated with the second serving cell. Additionally or alternatively, the UE 115 may receive the indicator via at least one transmission configuration indicator (TCI) state that indicates the spatial resources, time resources, and/or frequency resources for the reference signal associated with the second serving cell.

At action 706, the method 700 includes the UE 115 receiving, from the network unit 105, the reference signal associated with the second serving cell. The reference signal associated with the second serving cell may be a CSI-RS, A SSB, a DMRS, and/or other signal transmitted by the network unit in FR2.

At action 708, the method 700 includes the UE 115 determining precoding parameters for a scheduled PUSCH transmission in the second serving cell (e.g., FR2 serving cell). The UE 115 may determine precoding parameters for the scheduled PUSCH based on the reference signal associated with the second serving cell received at action 706. In some aspects, the UE 115 may receive an UL-grant DCI from the network unit scheduling a PUSCH communication in the second serving cell. The UL-grant DCI may indicate at least one of a sounding reference signal (SRS) resource indicator (SRI), a TPMI (transmitted precoding matrix indicator), or other suitable indicator associated with the first serving cell. The UE 115 may predict (e.g., determine) precoding information associated with the scheduled PUSCH in the second serving cell. The precoding information may be based on the indicated SRI and/or the TPMI associated with the first serving cell.

At action 710, the method 700 includes the UE 115 transmitting a PUSCH scheduled in the second serving cell to the network unit 105. The UE 115 may transmit the scheduled PUSCH in the second serving cell based on the predicted precoding information and the UL-grant DCI scheduling at action 708.

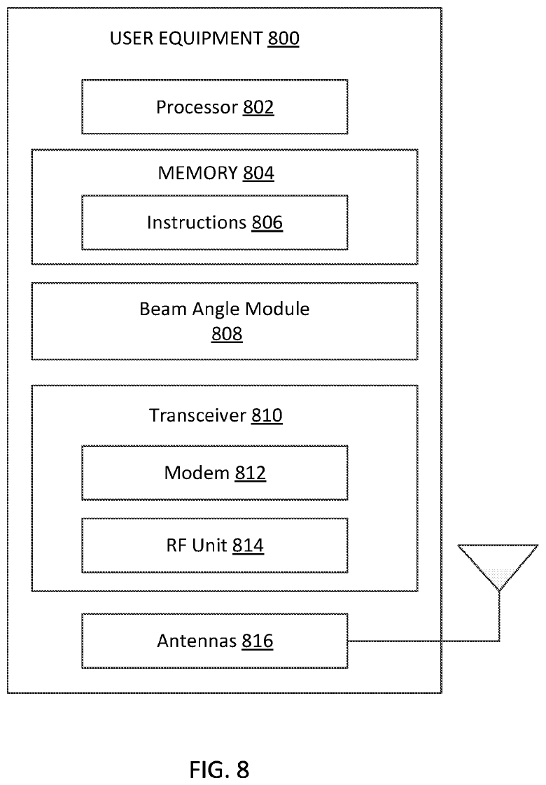

FIG. 8 is a block diagram of an exemplary UE 800 according to some aspects of the present disclosure. The UE 800 may be the UE 115 or the UE 120 in the network 100 or 200 as discussed above. As shown, the UE 800 may include a processor 802, a memory 804, a beam angle module 808, a transceiver 810 including a modem subsystem 812 and a radio frequency (RF) unit 814, and one or more antennas 816. These elements may be coupled with each other and in direct or indirect communication with each other, for example via one or more buses.

The processor 802 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 804 includes a non-transitory computer-readable medium. The memory 804 may store instructions 806. The instructions 806 may include instructions that, when executed by the processor 802, cause the processor 802 to perform the operations described herein with reference to the UEs 115 in connection with aspects of the present disclosure, for example, aspects of FIGS. 3-7. Instructions 806 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The beam angle module 808 may be implemented via hardware, software, or combinations thereof. For example, the beam angle may be implemented as a processor, circuit, and/or instructions 806 stored in the memory 804 and executed by the processor 802. The beam angle module 808 may transmit, to a network unit (e.g., the BS 105, the RU 240, the DU 230, the CU 210, or the network unit 900), a first reference signal having a first beam direction. The beam angle module 808 may receive, from the network unit, a second reference signal having a second beam direction. The beam angle module 808 may transmit, to the network unit, an indicator indicating a difference between a first angle associated with the first beam direction and a second angle associated with the second beam direction.

In some aspects, the beam angle module 808 may transmit, to the network unit (e.g., the BS 105, the RU 240, the DU 230, the CU 210, or the network unit 900), a request in a first serving cell for a reference signal associated with a second serving cell, wherein the second serving cell is different from the first serving cell. The beam angle module 808 may receive, from the network unit based on the request, an indicator indicating resources for the reference signal associated with the second serving cell. The beam angle module 808 may receive, from the network unit, the reference signal associated with the second serving cell. The beam angle module 808 may transmit, to the network unit transmitting, to the network unit based on the reference signal associated with the second serving cell, a physical uplink shared channel (PUSCH) scheduled in the second serving cell

As shown, the transceiver 810 may include the modem subsystem 812 and the RF unit 814. The transceiver 810 can be configured to communicate bi-directionally with other devices, such as the BSs 105 and/or the UEs 115. The modem subsystem 812 may be configured to modulate and/or encode the data from the memory 804 and the according to a modulation and coding scheme (MCS), e.g., a low-density parity check (LDPC) coding scheme, a turbo coding scheme, a convolutional coding scheme, a digital beamforming scheme, etc. The RF unit 814 may be configured to process (e.g., perform analog to digital conversion or digital to analog conversion, etc.) modulated/encoded data from the modem subsystem 812 (on outbound transmissions) or of transmissions originating from another source such as a UE 115 or a BS 105. The RF unit 814 may be further configured to perform analog beamforming in conjunction with the digital beamforming. Although shown as integrated together in transceiver 810, the modem subsystem 812 and the RF unit 814 may be separate devices that are coupled together to enable the UE 800 to communicate with other devices.

The RF unit 814 may provide the modulated and/or processed data, e.g. data packets (or, more generally, data messages that may contain one or more data packets and other information), to the antennas 816 for transmission to one or more other devices. The antennas 816 may further receive data messages transmitted from other devices. The antennas 816 may provide the received data messages for processing and/or demodulation at the transceiver 810. The antennas 816 may include multiple antennas of similar or different designs in order to sustain multiple transmission links. The RF unit 814 may configure the antennas 816.

In some instances, the UE 800 can include multiple transceivers 810 implementing different RATs (e.g., NR and LTE). In some instances, the UE 800 can include a single transceiver 810 implementing multiple RATs (e.g., NR and LTE). In some instances, the transceiver 810 can include various components, where different combinations of components can implement RATs.

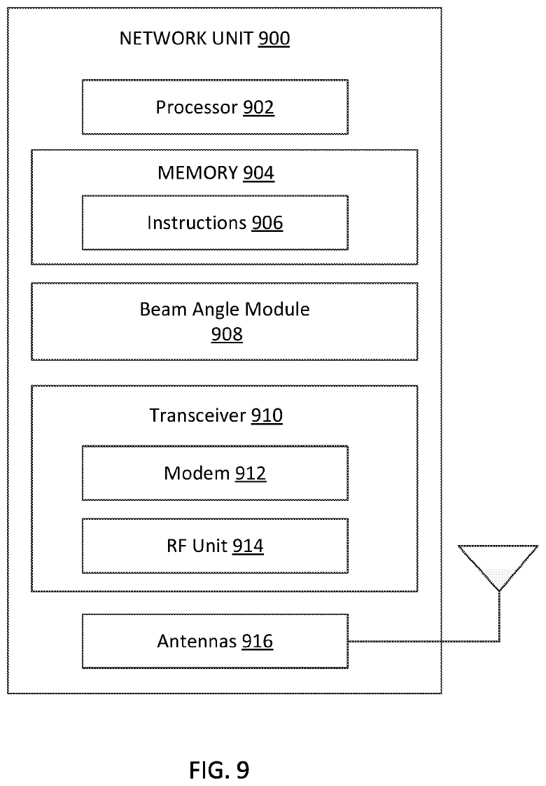

FIG. 9 is a block diagram of an exemplary network unit 900 according to some aspects of the present disclosure. The network unit 900 may be a BS 105, the CU 210, the DU 230, or the RU 240, as discussed above. As shown, the network unit 900 may include a processor 902, a memory 904, a beam angle module908, a transceiver 910 including a modem subsystem 912 and a RF unit 914, and one or more antennas 916. These elements may be coupled with each other and in direct or indirect communication with each other, for example via one or more buses.

The processor 902 may have various features as a specific-type processor. For example, these may include a CPU, a DSP, an ASIC, a controller, a FPGA device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 904 may include a non-transitory computer-readable medium. The memory 904 may store instructions 906. The instructions 906 may include instructions that, when executed by the processor 902, cause the processor 902 to perform operations described herein, for example, aspects of FIGS. 3-7. Instructions 906 may also be referred to as code, which may be interpreted broadly to include any type of computer-readable statement(s).

The beam angle module 908 may be implemented via hardware, software, or combinations thereof. For example, the beam angle module 908 may be implemented as a processor, circuit, and/or instructions 906 stored in the memory 904 and executed by the processor 902.

In some aspects, the beam angle module 908 may implement the aspects of FIGS. 3-7. For example, the beam angle module 908 may transmit, to a user equipment (UE), a channel state information (CSI) report configuration. The beam angle module 908 may transmit, to the UE, a plurality of reference signals. The beam angle module 908 may receive, from the UE, at least one CSI report based on the CSI report configuration, the at least one CSI report indicating one or more first reference signals of the plurality of reference signals satisfying a first threshold and one or more second reference signals of the plurality of reference signals satisfying a second threshold, wherein the second threshold is different from the first threshold.

Additionally or alternatively, the beam angle module 908 can be implemented in any combination of hardware and software, and may, in some implementations, involve, for example, processor 902, memory 904, instructions 906, transceiver 910, and/or modem 912.

As shown, the transceiver 910 may include the modem subsystem 912 and the RF unit 914. The transceiver 910 can be configured to communicate bi-directionally with other devices, such as the UEs 115 and/or 600. The modem subsystem 912 may be configured to modulate and/or encode data according to a MCS, e.g., a LDPC coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data from the modem subsystem 912 (on outbound transmissions) or of transmissions originating from another source such as a UE 115 or UE 800. The RF unit 914 may be further configured to perform analog beamforming in conjunction with the digital beamforming. Although shown as integrated together in transceiver 910, the modem subsystem 912 and/or the RF unit 914 may be separate devices that are coupled together at the network unit 900 to enable the network unit 900 to communicate with other devices.

The RF unit 914 may provide the modulated and/or processed data, e.g. data packets (or, more generally, data messages that may contain one or more data packets and other information), to the antennas 916 for transmission to one or more other devices. This may include, for example, a configuration indicating a plurality of sub-slots within a slot according to aspects of the present disclosure. The antennas 916 may further receive data messages transmitted from other devices and provide the received data messages for processing and/or demodulation at the transceiver 910. The antennas 916 may include multiple antennas of similar or different designs in order to sustain multiple transmission links.

In some instances, the network unit 900 can include multiple transceivers 910 implementing different RATs (e.g., NR and LTE). In some instances, the network unit 900 can include a single transceiver 910 implementing multiple RATs (e.g., NR and LTE). In some instances, the transceiver 910 can include various components, where different combinations of components can implement RATs.

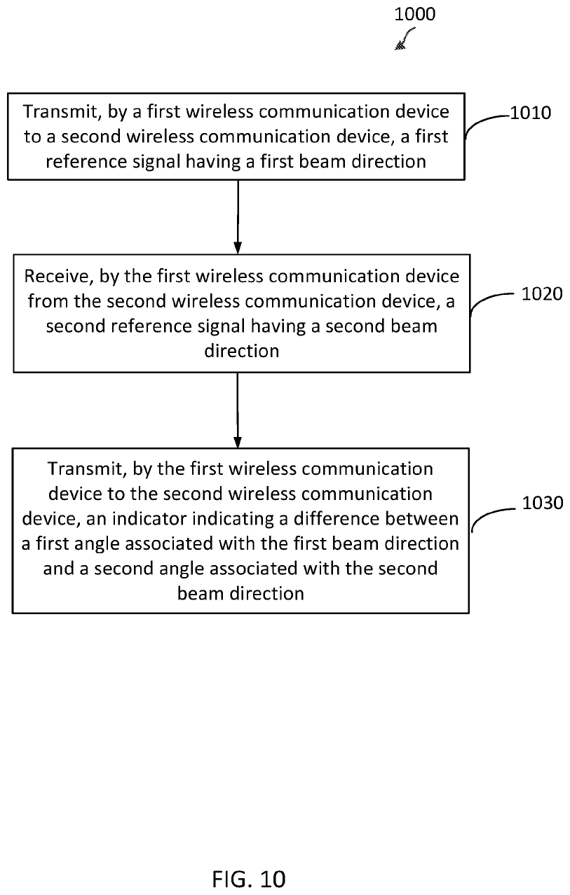

FIG. 10 is a flow diagram of a communication method 1000 according to some aspects of the present disclosure. Aspects of the method 1000 can be executed by a computing device (e.g., a processor, processing circuit, and/or other suitable component) of a wireless communication device or other suitable means for performing the aspects. For example, a wireless communication device, such as the UE 115, the UE 120, or the UE 800, may utilize one or more components, such as the processor 802, the memory 804, the beam angle module 808, the transceiver 810, the modem 812, and the one or more antennas 816, to execute aspects of method 1000. A wireless communication device, such as the BS 105, the RU 1240, the DU 1230, the CU 1210, and/or the network unit 900 may utilize one or more components, such as the processor 902, the memory 904, the beam angle module 908, the transceiver 910, the modem 912, and the one or more antennas 916, to execute aspects of method 1000. The method 1000 may employ similar mechanisms as in the networks 100 and 200 and the aspects and actions described with respect to FIGS. 3-7. As illustrated, the method 1000 includes a number of enumerated aspects, but the method 1000 may include additional aspects before, after, and in between the enumerated aspects. In some aspects, one or more of the enumerated aspects may be omitted or performed in a different order.

At action 1010, the method 1000 includes a first wireless communication device transmitting a first reference signal having a first beam direction to a second wireless communication device. In some aspects, the first wireless communication device may be a UE (e.g., the UE 115, the UE 120, or the UE 800) and the second wireless communication device may be a network unit (e.g., the BS 105, the RU 1240, the DU 1230, the CU 1210, and/or the network unit 900). Additionally or alternatively, the first wireless communication device may be a network unit (e.g., the BS 105, the RU 1240, the DU 1230, the CU 1210, and/or the network unit 900) and the second wireless communication device may be a UE (e.g., the UE 115, the UE 120, or the UE 800).

In some aspects, the first wireless communication device transmitting the first reference signal may include the first wireless communication device transmitting a plurality of first reference signals. The first reference signal(s) may be transmitted in at least frequency range 1 (FR1). In some instances, the FR1 may include frequencies in the range of about 4.1 GHz to about 7.125 GHz. In addition to or in lieu of FR1, the first reference signal(s) may be transmitted in one or more other frequency ranges.

In some aspects, the first reference signal may be transmitted in a first beam direction (e.g., a beam pointing direction). The first wireless communication device may support directional beamforming (e.g., spatial filtering, directional transmission, and/or directional reception) that may enable the first wireless communication device to transmit the first reference signal(s) in one or more particular directions. Directional beamforming may enable the first wireless communication device to shape and/or steer the transmission of the first reference signal(s) in a first beam direction along a spatial path between the first wireless communication device and the second wireless communication device. Beamforming may be achieved by combining signals communicated via antenna elements of the first wireless communication device such that some signals propagating at particular orientations with respect to the antenna array experience constructive interference while others experience destructive interference. The adjustment of signals communicated via the antenna elements may include applying amplitude offsets, and/or phase offsets to the first reference signal carried via the antenna elements associated with the first wireless communication device.

When the first wireless communication device is a UE and the second wireless communication device is a network unit, the first reference signal may be a sounding reference signal (SRS). The SRS may be a known sequence (e.g., a Zadoff-Chu sequence or other sequence) transmitted by the UE to the network unit to enable the network unit to estimate an uplink channel. The SRS may provide the network unit information about the effects of multipath fading, scattering, Doppler, and/or power loss of the transmitted SRS.

When the first wireless communication device is a network unit and the second wireless communication device is a UE, the first reference signal may be a channel state information-reference signal (CSI-RS). The CSI-RS may be a reference signal used in the downlink direction for the purpose of channel sounding and may be used by the UE to measure one or more characteristics of the radio channel. The CSI-RSs may include zero power channel state information reference signals (ZP-CSI-RSs) and/or non-zero power channel state information reference signals (NZP-CSI-RSs). Additionally or alternatively, the first reference signal may be a synchronization signal block (SSB). The SSB may include a primary synchronization signal (PSS) and/or a secondary synchronization signal (SSS). The SSB may be transmitted by the network unit over a physical broadcast channel (PBCH). The PSS may enable timing synchronization (e.g., of a period and/or periodicity) and/or may indicate a physical layer identity value. The network unit may then transmit an SSS. The SSS may be associated with the PSS. The SSS may enable radio frame synchronization and/or may provide a cell identity value. In some instances, the cell identify value of the SSS may be combined with the physical layer identity value of the PSS to identify the cell.

At action 1020, the method 1000 includes the first wireless communication device receiving a second reference signal having a second beam direction from the second wireless communication device. In some aspects, the first wireless communication device receiving the second reference signal may include the first wireless communication device receiving a plurality of second reference signals. The second reference signal(s) may be received in at least frequency range 1 (FR1). In some instances, the FR1 may include frequencies in the range of about 4.1 GHz to about 7.125 GHz. In addition to or in lieu of FR1, the second reference signal(s) may be received in one or more other frequency ranges.

In some aspects, the second reference signal may be received in a second beam direction (e.g., a beam arrival direction). The second beam direction may have an angle of arrival (AOA) at the first wireless communication device. The AOA at the first wireless communication device may be different from the direction that the second reference signal was transmitted by the second wireless communication device (e.g., the beam pointing direction of the transmitted second reference signal). The AOA may be different from the beam pointing direction of the second reference signal due to multipath reflections in the communications channel.

When the first wireless communication device is a UE and the second wireless communication device is a network unit, the second reference signal may be a CSI-RS, an SSB, and/or other signal. When the first wireless communication device is a network unit and the second wireless communication device is a UE, the second reference signal may be an SRS or other signal.

At action 1030, the method 1000 includes the first wireless communication device transmitting an indicator to the second wireless communication device. The indicator may indicate a difference between a first angle associated with the first beam direction and a second angle associated with the second beam direction. In this regard, the first wireless communication device may transmit the indicator via at least one of a channel state information (CSI) report, a medium access control control element (MAC-CE), downlink control information (DCI), and/or uplink control information (UCI).

When the first wireless communication device is a UE and the second wireless communication device is a network unit, the UE may transmit the indicator multiplexed with other indicators and/or data (e.g., multiplexed with hybrid automatic repeat request

(HARQ) feedback, channel state information (CSI), a scheduling request (SR), and/or other indicators/data). In this regard, the UE may transmit the indicator frequency multiplexed with other indicators and/or data. Additionally or alternatively, the UE may transmit the indicator time multiplexed with other information and/or data. In some aspects, the UE may transmit the indicator multiplexed with other information and/or data based on a priority level associated with the indicator. In some aspects, the UCI may have a limited payload size and certain information (e.g., indicators, control data, HARQ feedback) may be included or omitted from the UCI payload based on priority levels associated with the information (e.g., priority levels of the indicators, control data, feedback) carried by the UCI. In some instances, the UE may receive the priority level(s) associated with the information to be carried by the UCI from the network unit. In some aspects, the priority level associated with the beam angle indicator may be based on the difference between the first angle associated with the first beam direction and the second angle associated with the second beam direction. For example, a smaller difference between the first and second angle may decrease the indicator priority level, whereas a larger difference between the first and second angle may increase the indicator priority level.

In some aspects, the first reference signal and the second reference signal may be associated with a first serving cell. The first serving cell may operate in an FR1 frequency band. When the first wireless communication device is a network unit and the second wireless communication device is a UE, the network unit may transmit the indicator to the UE via DCI that schedules a physical uplink shared channel (PUSCH) associated with a second serving cell. The second serving cell may be different from the first serving cell. The second serving cell may operate in an FR2 frequency range. In some instances, the FR2 frequency range may include frequencies in the range of about 24.25 GHz to about 52.6 GHz. In addition to or in lieu of FR2, the second serving cell may operate in one or more other frequency ranges. For example, the second serving cell may operate in frequency ranges above 52.6 GHz. In some aspects, the UE may use the received indicator to determine uplink precoding parameters for the PUSCH scheduled for transmission by the UE in the second serving cell. The UE may transmit the scheduled PUSCH to the network unit using the determined precoding parameters.

In some aspects, the network unit may transmit DCI to the UE that includes a sounding reference signal resource indicator (SRI) and/or a transmit precoding matrix index (TPMI) associated with the first serving cell. The SRI may indicate to the UE one or more SRS resources from an SRS resource set that are associated with SRS reference signals associated with the first cell (e.g., in FR1). The TPMI may indicate to the UE one or more precoding parameters associated with the scheduled PUSCH message.

In some aspects, the first angle associated with the first beam direction may be based on a beam pointing direction (e.g., beam transmission direction from the transmitting device). The beam pointing direction may be a center line of a transmission beam lobe. For example, when the first wireless communication device is a UE and the second wireless communication device is a network unit as shown in FIG. 3, UE 115 may have a beam pointing direction 314 of transmission beam lobe 316. Network unit 105 may have a beam pointing direction 310 of transmission beam lobe 308. The first angle may be an angle 318 between the beam pointing direction 314 and a reference line 320 (e.g., a vertical reference line). The UE may transmit the first reference signal (e.g., an SRS) intended for the network unit 105 along beam pointing direction 314. The second angle associated with the second beam direction may be a beam angle of arrival (AOA) 302. Beam AOA 302 may be an angle between the second reference signal (e.g., CSI-RS, SSB) received on reflected beam 304 and reference line 320. Network unit 105 may transmit the second reference signal along pointing direction 310. The second reference signal may be reflected off the object 306 and/or other objects. The reflected second reference signal may propagate on as reflected beam 304 to the UE 115. The UE 115 may measure the beam AOA 302 associated with the second reference signal using any suitable method. For example, the UE 115 may measure the beam AOA 302 associated with a plurality of delay paths based on a time difference of arrival and/or a received phase associated with the second reference signal. The beam AOA 302 may be represented as an azimuth angle and/or an elevation angle relative to the reference line 320 and/or other suitable reference line(s). The UE 115 may determine a difference between the angle 318 associated with the beam pointing direction 314 and the angle (e.g., beam AOA 302) associated with the reflected beam 304 (e.g., the second beam direction). The UE 115 may transmit the indicator indicating the difference between the angles of the transmitted first reference signal and received second reference signal to the network unit 105.

In some aspects, a smaller difference between the angles may indicate a better alignment and/or a better channel between the first and second wireless communication devices as compared to a larger difference between the first and second angles. A better channel between the first and second wireless communication devices may increase the performance and/or efficiency of the communication between the network unit and the UE. In some aspects, the difference between the first angle associated with the first beam direction in FR1 and the second angle associated with the second beam direction in FR1 may be used as a proxy for estimating channel conditions and/or beam failures between the network unit and the UE when operating in FR2 (e.g., when the UE transmits a PUSCH in a second serving cell operating in FR2). For example, a UE may determine a beam failure associated with the second serving cell operating in FR2 based on reference signals in the first serving cell operating in FR1. In some instances, the UE may determine the beam failure associated with the second serving cell based on a power delay profile (PDP) and/or an AOA of the reference signals in the first serving cell. In some instances, the UE may determine the beam failure associated with the second serving cell based on the PDP using one or more of a received signal strength indicator (RSSI) associated with the reference signals in the first serving cell, a reference signal received power (RSRP) associated with the reference signals in the first serving cell, a number of delay paths associated with the reference signals in the first serving cell, a reference signal received quality (RSRQ) associated with the reference signals in the first serving cell, and/or a signal-to-noise and interference ratio (SINR) associated with the reference signals in the first serving cell. In some instances, the UE may determine the beam failure associated with the second serving cell based on the AOA using one or more of a time difference of arrival and/or a received phase associated with the reference signals in the first serving cell.

In some aspects, the indicator indicating the difference between the first and second angles may indicate the difference in a number of degrees. The indicator may indicate the difference as a whole and/or fractional number of degrees. In some aspects, the indicator may indicate the difference as being within a range of degrees (e.g., between 0 and 5 degrees, between 5 and 10 degrees, or any suitable range(s) of degrees), with each range of degrees having an associated value or identifier.

In some aspects, the indicator may be a binary indicator (e.g., “0” or “1”) indicating whether the difference between the first angle and the second angle satisfies a threshold. For example, the binary indicator may indicate whether the difference is greater than (and/or equal to) a threshold or less than (and/or equal to) a threshold. In some aspects, the binary indicator may indicate whether the difference is within a range of degrees or out of a range of degrees.

In some aspects, the indicator indicating the difference between the first and second angles may indicate the difference relative to a previous indicator. For example, a first indicator may indicate the difference in a number of degrees. Subsequent indicators may indicate the difference in degrees or other values (e.g., based on one or more ranges) as a delta to the previously indicated number of degrees or other value.

In some aspects, the first wireless communication device may transmit the indicator to the second wireless communication device on a periodic, a semi-persistent, and/or an aperiodic basis. For example, the first wireless communication device may receive a request for the indicator from the second wireless communication device. The first wireless communication device may transmit the indicator in response to receiving the request. In this regard, the first wireless communication device may receive the request via at least one of a radio resource control (RRC) message, a semi-persistent activation state configuration via a medium access control control element (MAC-CE), an aperiodic triggering state configuration downlink control information (DCI), a channel state information (CSI) report setting, a MAC-CE, downlink control information (DCI), or uplink control information (UCI).

In some aspects, the first wireless communication device may transmit the indicator to the second wireless communication device based on a change (e.g., a rate of change and/or absolute change) in the difference between the first angle and the second angle. For example, the first wireless communication device may detect a rate of change in the angle difference over a time period. A change in orientation (e.g., vertical orientation and/or horizontal orientation) of the UE (e.g., when a user rotates the UE) may cause a change in the angle difference. The first wireless communication device may transmit the indicator to the second wireless communication device based on a rate of change in the angle difference satisfying a threshold (e.g., exceeding and/or equaling the threshold).

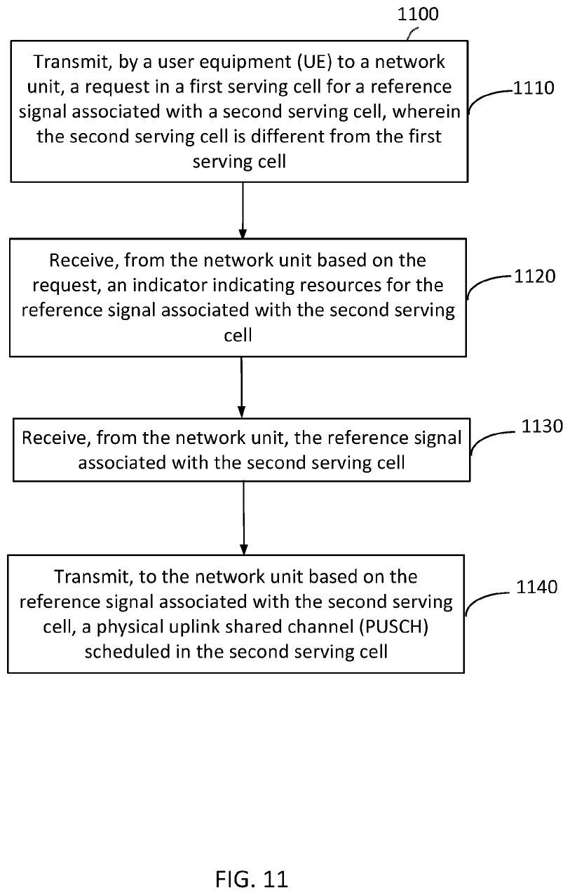

FIG. 11 is a flow diagram of a communication method 1100 according to some aspects of the present disclosure. Aspects of the method 1100 can be executed by a computing device (e.g., a processor, processing circuit, and/or other suitable component) of a wireless communication device or other suitable means for performing the aspects. For example, a wireless communication device, such as the UE 115, the UE 120, or the UE 800, may utilize one or more components, such as the processor 802, the memory 804, the beam angle module 808, the transceiver 810, the modem 812, and the one or more antennas 816, to execute aspects of method 1100. The method 1100 may employ similar mechanisms as in the networks 100 and 200 and the aspects and actions described with respect to FIGS. 3-7. As illustrated, the method 1100 includes a number of enumerated aspects, but the method 1100 may include additional aspects before, after, and in between the enumerated aspects. In some aspects, one or more of the enumerated aspects may be omitted or performed in a different order.

At action 1110, the method 1100 includes a UE (e.g., the UE 115, the UE 120, or the UE 800) transmitting, to a network unit, a request in a first serving cell for a reference signal associated with a second serving cell. In this regard, the UE may transmit the request to the network unit via UCI, a MAC-CE message, a CSI-RS report, a PUCCH message, and/or a PUSCH message. In some aspects, the reference signal associated with a second serving cell may include at least one of a channel state information reference signal (CSI-RS), a synchronization signal block (SSB), or a demodulation reference signal (DMRS).

The second serving cell may be different from the first serving cell. In this regard, the first serving cell may be a serving cell operating in at least FR1 while the second serving cell may be a serving cell operating in at least FR2. The FR1 may include frequencies in the range of about 4.1 GHz to about 7.125 GHz. In addition to or in lieu of FR1, the first serving cell may operate in one or more other frequency ranges. The FR2 frequency range may include frequencies in the range of about 24.25 GHz to about 52.6 GHz. In addition to or in lieu of FR2, the second serving cell may operate in one or more other frequency ranges. For example, the second serving cell may operate in frequency ranges above 52.6 GHz. In some aspects, the first serving cell may be in a master cell group (MCG) and the second serving cell may be in a secondary cell group (SCG). The wireless network (e.g., wireless network 100 or 200) may operate in a dual connectivity mode in which the UE is connected to the first serving cell in a master cell group (MCG) and the second serving cell in a secondary cell group (SCG). The MCG may be a group of serving cells associated with a master eNB (MeNB) operating at FR1 frequencies and/or one or more other frequency ranges. The SCG may be a group of serving cells associated with a secondary eNB (SeNB) operating at FR2 frequencies and/or one or more other frequency ranges.

In some aspects, the UE may receive a reference signal associated with the first serving cell from the network unit. The reference signal may be a CSI-RS, a SSB, a DMRS, and/or other signal transmitted in at least FR1. The UE may transmit the request for the reference signal associated with the second serving cell based on at least one parameter of a reference signal associated with the first serving cell received from the network unit. For example, the at least one parameter of the reference signal associated with the first serving cell may include an RSRP associated with the reference signal satisfying a threshold. In some aspects, the at least one parameter may include a rate of change of the RSRP associated with the reference signal satisfying a threshold. Additionally or alternatively, the UE may transmit the request for the reference signal associated with the second serving cell based on a difference between a scheduled rank associated with a scheduled PUSCH transmission and a determined rank associated with the scheduled PUSCH transmission satisfying a threshold. Additionally or alternatively, the UE may transmit the request for the reference signal associated with the second serving cell based on a difference between a scheduled modulation coding scheme (MCS) associated with the scheduled PUSCH and a determined MCS associated with the scheduled PUSCH satisfying a threshold.

At action 1120, the method 1100 includes a UE receiving an indicator from the network unit indicating resources for the reference signal associated with the second serving cell. The UE may receive the indicator from the network unit based on the request transmitted at action 1110. In this regard, the UE may receive the indicator via downlink control information (DCI) and/or other suitable messaging. The DCI may carry a sounding reference signal resource indicator (SRI) that indicates the spatial resources, time resources, and/or frequency resources for the reference signal associated with the second serving cell. Additionally or alternatively, the DCI may carry a transmit precoding matrix index (TPMI) that indicates the spatial resources, time resources, and/or frequency resources for the reference signal associated with the second serving cell. Additionally or alternatively, the UE may receive the indicator via at least one transmission configuration indicator (TCI) state that indicates the spatial resources, time resources, and/or frequency resources for the reference signal associated with the second serving cell.

At action 1130, the method 1100 includes a UE receiving, from the network unit, the reference signal associated with the second serving cell. The reference signal associated with the second serving cell may be a CSI-RS, A SSB, a DMRS, and/or other signal transmitted by the network unit in FR2.

At action 1140, the method 1100 includes a UE transmitting a PUSCH scheduled in the second serving cell to the network unit. The UE may transmit the scheduled PUSCH based on the reference signal associated with the second serving cell received at action 1130. For example, the UE may determine precoding parameters for the scheduled PUSCH based on the reference signal associated with the second serving cell. In some aspects, the UE may receive an UL-grant DCI from the network unit scheduling a PUSCH communication in the second serving cell. The UL-grant DCI may indicate at least one of a sounding reference signal (SRS) resource indicator (SRI), a TPMI (transmitted precoding matrix indicator), or other suitable indicator associated with the first serving cell. The UE may predict (e.g., determine) precoding information associated with the scheduled PUSCH in the second serving cell. The precoding information may be based on the indicated SRI and/or the TPMI associated with the first serving cell. The UE may transmit the scheduled PUSCH in the second serving cell based on the predicted precoding information and the UL-grant DCI scheduling.

Further aspects of the present disclosure include the following:

Aspect 1 includes a method of wireless communication, the method comprising transmitting, by a first wireless communication device to a second wireless communication device, a first reference signal having a first beam direction; receiving, by the first wireless communication device from the second wireless communication device, a second reference signal having a second beam direction; and transmitting, by the first wireless communication device to the second wireless communication device, an indicator indicating a difference between a first angle associated with the first beam direction and a second angle associated with the second beam direction.

Aspect 2 includes the method of aspect 1, wherein the first angle associated with the first beam direction is a beam transmission angle and the second angle associated with the second beam direction is a beam angle of arrival.

Aspect 3 includes the method of any of aspects 1-2 wherein the transmitting the indicator comprises transmitting the indicator via at least one of a channel state information (CSI) report; a medium access control control element (MAC-CE); downlink control information (DCI); or uplink control information (UCI).

Aspect 4 includes the method of any of aspects 1-3, wherein the indicator indicates the difference as a number of degrees between the first angle and the second angle.

Aspect 5 includes the method of any of aspects 1-4, wherein the indicator comprises a binary indicator indicating whether the difference between the first angle and the second angle satisfies a threshold.

Aspect 6 includes the method of any of aspects 1-5, wherein the first wireless communication device is a network unit; and the second wireless communication device is a user equipment (UE).

Aspect 7 includes the method of any of aspects 1-6, wherein the first wireless communication device is a user equipment (UE); and the second wireless communication device is a network unit.

Aspect 8 includes the method of any of aspects 1-7, wherein the first reference signal is at least one of a channel state information reference signal (CSI-RS); or a synchronization signal block (SSB); and the second reference signal is a sounding reference signal (SRS).

Aspect 9 includes the method of any of aspects 1-8, wherein the second reference signal is at least one of a channel state information reference signal (CSI-RS); or a synchronization signal block (SSB); and the first reference signal is a sounding reference signal (SRS).

Aspect 10 includes the method of any of aspects 1-9, wherein the transmitting the first reference signal comprises transmitting the first reference signal in a frequency range 1 (FR1); and the receiving the second reference signal comprises receiving the second reference signal in the FR1; and further comprising communicating, by the first wireless communication device with the second wireless communication device based on the indicator, a communication in at least one of a frequency range 2 (FR2), a low band FR2; a high band FR2; a frequency range 4 (FR4); a millimeter wave frequency range; or a terahertz frequency range.

Aspect 11 includes the method of any of aspects 1-10, further comprising receiving, by the first wireless communication device from the second wireless communication device, a request for the indicator, wherein the transmitting the indicator comprises transmitting the indicator in response to the request.

Aspect 12 includes the method of any of aspects 1-11, wherein the receiving the request comprises receiving the request via at least one of a radio resource control (RRC) message; a semi-persistent activation state configuration via a medium access control control element (MAC-CE); an aperiodic triggering state configuration downlink control information (DCI); a channel state information (CSI) report setting; a MAC-CE; downlink control information (DCI); or uplink control information (UCI).

Aspect 13 includes the method of any of aspects 1-12, wherein the transmitting the indicator comprises transmitting, via uplink control information (UCI) based on a priority level associated with the indicator, the indicator multiplexed with control information.

Aspect 14 includes the method of any of aspects 1-13, wherein the transmitting the indicator comprises transmitting the indicator based on a change in the difference between the first angle and the second angle.

Aspect 15 includes the method of any of aspects 1-14, wherein the indicator indicates the difference between the first angle and the second angle relative to a previous indicator of the difference between the first angle and the second angle.

Aspect 16 includes the method of any of aspects 1-15, wherein the first reference signal and the second reference signal are associated with a first serving cell; and the transmitting the indicator comprises transmitting the indicator via downlink control information (DCI) that schedules a physical uplink shared channel (PUSCH) associated with a second serving cell, the second serving cell being different than the first serving cell.

Aspect 17 includes the method of any of aspects 1-16, further comprising determining, by the first wireless communication device, one or more precoding parameters associated with the PUSCH based on the indicator.

Aspect 18 method of wireless communication performed by a user equipment (UE), the method comprising transmitting, to a network unit, a request in a first serving cell for a reference signal associated with a second serving cell, wherein the second serving cell is different from the first serving cell; receiving, from the network unit based on the request, an indicator indicating resources for the reference signal associated with the second serving cell; receiving, from the network unit, the reference signal associated with the second serving cell; and transmitting, to the network unit based on the reference signal associated with the second serving cell, a physical uplink shared channel (PUSCH) scheduled in the second serving cell.

Aspect 19 includes the method of aspect 18, wherein the reference signal associated with the second serving cell comprise at least one of a channel state information reference signal (CSI-RS); a synchronization signal block (SSB); or a demodulation reference signal (DMRS).

Aspect 20 includes the method of any of aspects 18-19, wherein the transmitting the request in the first serving cell comprises transmitting the request in a frequency range 1 (FR1); and the receiving the reference signal associated with the second serving cell comprises receiving the reference signal in a frequency range 2 (FR2).

Aspect 21 includes the method of any of aspects 18-20, further comprising receiving, from the network unit, a reference signal associated with the first serving cell, wherein the transmitting the request is based on at least one parameter of the reference signal associated with the first serving cell.

Aspect 22 includes the method of any of aspects 18-21, wherein the at least one parameter of the reference signal associated with the first serving cell comprises at least one of a rate of change of the at least one parameter satisfying a first threshold; a reference signal received power (RSRP) associated with the reference signal satisfying a second threshold; a difference between a scheduled rank associated with the PUSCH and a determined rank associated with the PUSCH satisfying a third threshold; or a difference between a scheduled modulation coding scheme (MCS) associated with the PUSCH and a determined MCS associated with the PUSCH satisfying a fourth threshold

Aspect 23 includes the method of any of aspects 18-22, wherein the receiving the indicator comprises receiving the indicator via downlink control information (DCI); and the DCI carries at least one of a sounding reference signal resource indicator (SRI); or a transmit precoding matrix index (TPMI) associated with the first serving cell.

Aspect 24 includes the method of any of aspects 18-23, wherein the receiving the indicator comprises receiving the indicator via at least one transmission configuration indicator (TCI) state identifier.

Aspect 25 includes the method of any of aspects 18-24, further comprising receiving, from the network unit, an UL-grant DCI scheduling a PUSCH associated with the second serving cell, wherein the UL-grant DCI further indicates at least one of a sounding reference signal (SRS) resource indicator (SRI) and a TPMI (transmitted precoding matrix indicator) associated with the first serving cell, predicting precoding information associated with the PUSCH associated with the second serving cell, based at least in part on at least one of the indicated SRI or the TPMI associated with the first serving cell; transmitting the PUSCH associated with the second serving cell based on the predicted precoding information and the UL-grant DCI scheduling.

Aspect 26 includes a non-transitory computer-readable medium storing one or more instructions for wireless communication, the one or more instructions comprising one or more instructions that, when executed by one or more processors of a wireless communication device, cause the wireless communication device to perform any one of aspects 1-17.

Aspect 27 includes a non-transitory computer-readable medium storing one or more instructions for wireless communication, the one or more instructions comprising one or more instructions that, when executed by one or more processors of a user equipment (UE), cause the UE to perform any one of aspects 18-25.

Aspect 28 includes a user equipment (UE) comprising one or more means to perform any one or more of aspects 1-17.

Aspect 29 includes a network unit comprising one or more means to perform any one or more of aspects 1-17.

Aspect 30 includes a user equipment (UE) comprising one or more means to perform one or more of aspects 18-25.

Aspect 31 includes a user equipment (UE) comprising a memory, a transceiver and at least one processor coupled to the memory and the transceiver, wherein the UE is configured to perform any one or more of aspects 1-17.

Aspect 32 includes a network unit comprising a memory, a transceiver and at least one processor coupled to the memory and the transceiver, wherein the network unit is configured to any one or more of aspects 1-17.

Aspect 33 includes a user equipment (UE) comprising a memory, a transceiver and at least one processor coupled to the memory and the transceiver, wherein the UE is configured to any one or more of aspects 18-25.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1. A method of wireless communication, the method comprising:
transmitting, by a first wireless communication device to a second wireless communication device, a first reference signal having a first beam direction;
receiving, by the first wireless communication device from the second wireless communication device, a second reference signal having a second beam direction; and
transmitting, by the first wireless communication device to the second wireless communication device, an indicator indicating a difference between a first angle associated with the first beam direction and a second angle associated with the second beam direction.

2. The method of claim 1, wherein the first angle associated with the first beam direction is a beam transmission angle and the second angle associated with the second beam direction is a beam angle of arrival.

3. The method of claim 1, wherein the transmitting the indicator comprises transmitting the indicator via at least one of:
a channel state information (CSI) report;
a medium access control control element (MAC-CE);
downlink control information (DCI); or
uplink control information (UCI).

4. The method of claim 1, wherein at least one of:
the indicator indicates the difference as a number of degrees between the first angle and the second angle; or
the indicator comprises a binary indicator indicating whether the difference between the first angle and the second angle satisfies a threshold.

5. The method of claim 1, wherein:
the first wireless communication device is a network unit and the second wireless communication device is a user equipment (UE); or
the first wireless communication device is a user equipment (UE) and
the second wireless communication device is a network unit.

6. The method of claim 1, wherein the first reference signal is at least one of:
a channel state information reference signal (CSI-RS); or
a synchronization signal block (SSB); and
the second reference signal is a sounding reference signal (SRS).

7. The method of claim 1, wherein the second reference signal is at least one of:
a channel state information reference signal (CSI-RS); or
a synchronization signal block (SSB); and
the first reference signal is a sounding reference signal (SRS).

8. The method of claim 1, wherein:
the transmitting the first reference signal comprises transmitting the first reference signal in a frequency range 1 (FR1); and
the receiving the second reference signal comprises receiving the second reference signal in the FR1; and
further comprising:
communicating, by the first wireless communication device with the second wireless communication device based on the indicator, a communication in at least one of:
a frequency range 2 (FR2);
a low band FR2;
a high band FR2;
a frequency range 4 (FR4);
a millimeter wave frequency range; or
a terahertz frequency range.

9. The method of claim 1, further comprising:
receiving, by the first wireless communication device from the second wireless communication device, a request for the indicator, wherein the transmitting the indicator comprises transmitting the indicator in response to the request.

10. The method of claim 1, wherein the transmitting the indicator comprises transmitting, via uplink control information (UCI) based on a priority level associated with the indicator, the indicator multiplexed with control information.

11. The method of claim 1, wherein the transmitting the indicator comprises transmitting the indicator based on a change in the difference between the first angle and the second angle.

12. The method of claim 1, wherein the indicator indicates the difference between the first angle and the second angle relative to a previous indicator of the difference between the first angle and the second angle.

13. A method of wireless communication performed by a user equipment (UE), the method comprising:
transmitting, to a network unit, a request in a first serving cell for a reference signal associated with a second serving cell, wherein the second serving cell is different from the first serving cell;
receiving, from the network unit based on the request, an indicator indicating resources for the reference signal associated with the second serving cell;
receiving, from the network unit, the reference signal associated with the second serving cell; and
transmitting, to the network unit based on the reference signal associated with the second serving cell, a physical uplink shared channel (PUSCH) scheduled in the second serving cell.

14. The method of claim 13, wherein the reference signal associated with the second serving cell comprise at least one of:
a channel state information reference signal (CSI-RS);
a synchronization signal block (SSB); or
a demodulation reference signal (DMRS).

15. The method of claim 13, wherein:
the transmitting the request in the first serving cell comprises transmitting the request in a frequency range 1 (FR1); and
the receiving the reference signal associated with the second serving cell comprises receiving the reference signal in a frequency range 2 (FR2).

16. A first wireless communication device comprising:
a memory;
a transceiver; and
at least one processor coupled to the memory and the transceiver, wherein the first wireless communication device is configured to:
transmit, to a second wireless communication device, a first reference signal having a first beam direction;
receive, from the second wireless communication device, a second reference signal having a second beam direction; and
transmit, to the second wireless communication device, an indicator indicating a difference between a first angle associated with the first beam direction and a second angle associated with the second beam direction.

17. The first wireless communication device of claim 16, wherein the first angle associated with the first beam direction is a beam transmission angle and the second angle associated with the second beam direction is a beam angle of arrival.

18. The first wireless communication device of claim 16, wherein the first wireless communication device is further configured to transmit the indicator via at least one of:
a channel state information (CSI) report;
a medium access control control element (MAC-CE);
downlink control information (DCI); or
uplink control information (UCI).

19. The first wireless communication device of claim 16, wherein at least one of:
the indicator indicates the difference as a number of degrees between the first angle and the second angle; or
the indicator comprises a binary indicator indicating whether the difference between the first angle and the second angle satisfies a threshold.

20. The first wireless communication device of claim 16, wherein:
the first wireless communication device is a network unit and the second wireless communication device is a user equipment (UE); or
the first wireless communication device is a user equipment (UE) and
the second wireless communication device is a network unit.

21. The first wireless communication device of claim 16, wherein the first reference signal is at least one of:
a channel state information reference signal (CSI-RS); or
a synchronization signal block (SSB); and
the second reference signal is a sounding reference signal (SRS).

22. The first wireless communication device of claim 16, wherein the second reference signal is at least one of:
a channel state information reference signal (CSI-RS); or
a synchronization signal block (SSB); and
the first reference signal is a sounding reference signal (SRS).

23. The first wireless communication device of claim 16, wherein the first wireless communication device is further configured to:
transmit the first reference signal in a frequency range 1 (FR1);
receive the second reference signal in the FR1; and
communicate, with the second wireless communication device based on the indicator, a communication in at least one of:
a frequency range 2 (FR2);
a low band FR2;
a high band FR2;
a frequency range 4 (FR4);
a millimeter wave frequency range; or
a terahertz frequency range.

24. The first wireless communication device of claim 16, wherein the first wireless communication device is further configured to:
receive, from the second wireless communication device, a request for the indicator; and
transmit the indicator in response to the request.

25. The first wireless communication device of claim 16, wherein the first wireless communication device is further configured to:
transmit, via uplink control information (UCI) based on a priority level associated with the indicator, the indicator multiplexed with control information.

26. The first wireless communication device of claim 16, wherein the first wireless communication device is further configured to:
transmit the indicator based on a change in the difference between the first angle and the second angle.

27. The first wireless communication device of claim 16, wherein the indicator indicates the difference between the first angle and the second angle relative to a previous indicator of the difference between the first angle and the second angle.

28. A user equipment (UE) comprising:
a memory;
a transceiver; and
at least one processor coupled to the memory and the transceiver, wherein the UE is configured to:
transmit, to a network unit, a request in a first serving cell for a reference signal associated with a second serving cell, wherein the second serving cell is different from the first serving cell;
receive, from the network unit based on the request, an indicator indicating resources for the reference signal associated with the second serving cell;
receive, from the network unit, the reference signal associated with the second serving cell; and
transmit, to the network unit based on the reference signal associated with the second serving cell, a physical uplink shared channel (PUSCH) scheduled in the second serving cell.

29. The UE of claim 28, wherein the reference signal associated with the second serving cell comprise at least one of:
a channel state information reference signal (CSI-RS);
a synchronization signal block (SSB); or
a demodulation reference signal (DMRS).

30. The UE of claim 28, wherein the UE is further configured to:
transmit the request in a frequency range 1 (FR1); and
receive the reference signal in a frequency range 2 (FR2).
